(19) United States
(12) Patent Application Publication
(10) Pub. No.: US 2002/0195828 A1
(43) Pub. Date: Dec. 26, 2002

(54) Closure device

(75) Inventor: Karsten Gebhard, Solingen (DE)

Correspondence Address: OSTROLENK FABER GERB & SOFFEN, 1180 AVENUE OF THE AMERICAS, NEW YORK, NY, 100368403

(73) Assignee: Happich Fahrzeug- und Industrieteile GmbH

(21) Appl. No.: 10/173,455

(22) Filed: Jun. 14, 2002

(30) Foreign Application Priority Data
Jun. 20, 2001 (DE) 101 29 657.6

(51) Int. Cl. E05C 19/00

(52) U.S. Cl. 292/302

(57) ABSTRACT

A closure device for a door hung on a frame wherein the door is pivotable between a closed position and an open position. A lock is disposed on the door and a locking bolt assigned thereto is on the frame, behind which locking bolt the lock engages when the door is closed. In its functioning position, the bolt projects into the door frame aperture. The locking bolt is disposed on the frame to be moveable between its functioning position and a nonfunctioning position which leaves the frame aperture free.

### BACKGROUND OF THE INVENTION

The invention relates to a closure device for a door that is hung on a frame so that the door is pivotable between a closed position and an open position. The closure device is especially a door for a mobile home, trailer or the like. A lock is disposed on the door and a respective locking bolt is on the frame, behind which locking bolt the lock engages when the door is closed and which in its functioning position projects into the frame aperture.

Closure devices of the above-mentioned type have been conventional for many years and have also generally proven their value. Nevertheless, there is substantial room for improvement, especially with regard to the latching or locking bolt disposed on the door frame. The arrangement of the locking bolt has regularly given grounds for complaint, because in certain installations, as in general in mobile homes, trailers, and the like, but also in transporters or vehicles with special superstructures, it projects relatively far into the door/frame aperture. Users have complained repeatedly that they have knocked against the locking bolt and may have sustained painful injuries. For small children, the injuries may include head injuries. There have also been complaints that articles of clothing, handbag straps, and the like, easily catch on the locking bolt and are torn or damaged.

In order to remedy these situations, various guards for the locking bolt have been developed. They include guard plates (e.g. U.S. Pat. No. 3,240,524) and pivoting locking bolt covers (e.g. DE 299 23 837 U1). However, these developments merely reduce the risk of injury.

### SUMMARY OF THE INVENTION

It is therefore an object of the present invention, to eliminate the defects described from closure devices of the type mentioned at the outset, and to take precautions to avoid risk of injury or risk of damage to clothing and the like from the locking bolt.

According to the invention, the locking bolt disposed on the frame is movable between its functioning position and a nonfunctioning position which leaves the frame free of an aperture.

According to the invention, the locking bolt is in its functioning position when the door is closing or closed, in which position the lock engages behind the bolt, and the bolt can be moved into a nonfunctioning position when the door is opening or open. In the nonfunctioning position, the locking bolt leaves the frame free of an aperture, providing the particular advantages that injuries that might be caused by being caught on the locking bolt are avoided and that the usable door or frame aperture is enlarged.

According to the invention, the locking bolt can be moved by manually actuated means, particularly a mechanical actuating lever which engages directly on the locking bolt or permits movement of the locking bolt via a Bowden cable, a linkage, an electrical actuator, a solenoid, a hydraulic system or a pneumatic system.

Preferably, however, the locking bolt may be movable via an automatic actuation system linked to movement of the door. In this case, for accomplishing automatic actuation of the locking bolt during opening/closing of the door, a mechanical coupling to the door movement may be provided, e.g. a Bowden cable, a linkage, an electrical actuator, a solenoid, a hydraulic system, a pneumatic system, or the like through a sensor drive and responsive to door movement.

A particular embodiment of the invention may control the speed of movement of the locking bolt either during the transition from the functioning position or into the nonfunctioning position as a function of door movement.

The locking bolt may be disposed on the frame of the door and is optionally movable in either translation or rotation. Within the scope of the invention, the locking bolt may be replaced with a locking hasp, or the closure device for doors may be used according to the invention equally for flaps, and the like. The invention includes the lock being on the frame while the locking bolt is on the door, which may be advantageous in some installations.

### BRIEF DESCRIPTION OF THE DRAWING

An embodiment of the invention is described below with reference to the drawing.

FIG. 1 shows a closure device according to the invention on a vehicle door.

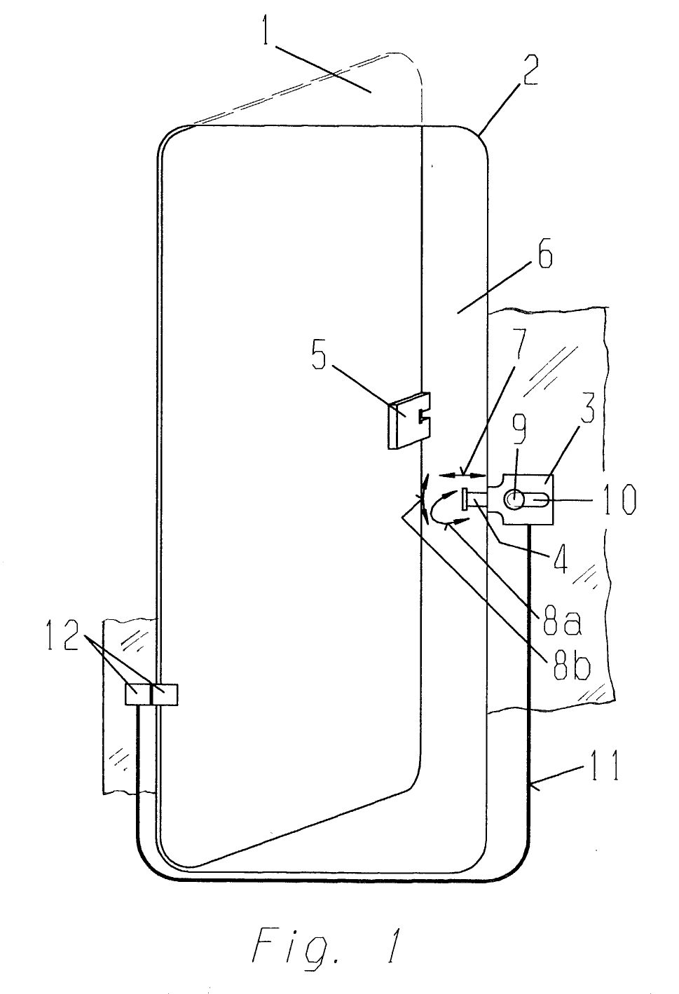

### DESCRIPTION OF A PREFERRED EMBODIMENT

The drawing shows, in a simplified presentation, a door 1 which is hung on and pivotable on hinges (not shown) on a door frame 2. A housing 3 disposed on the frame 2 supports a locking bolt 4. A lock 5 is fixed on the door 1. This may be a commercially available twist-type spring lock.

The locking bolt 4 is movable in the housing 3 between a functioning position shown, in which it projects into the frame aperture 6, and a nonfunctioning position, in which it is free of the frame aperture 6. Movement of the locking bolt 4 here may be translational, as shown by double arrow 7, or rotational, in the direction of the arrow 8, 8a, 8b. What is important is that when the locking bolt 4 is not needed, which is likely when the door 1 is open, it can be moved out of the frame aperture 6, to eliminate the constriction of the free aperture space and reduce the risk of injury. It is also important that the locking bolt 4 adopts its functioning position, as shown, during closing of the door 1, so that the lock 5 can engage afterward.

For accomplishing this movement sequence of the locking bolt, in a simple case, a handle 9 may be actively connected to the locking bolt 4. The handle 9 may be received in the housing 3 so as to be pivotable or to be displaceable along a slot 10. As soon as the locking bolt 4 is released by the lock and the door 1 has been opened, the locking bolt 4 can be moved by hand into a nonfunctioning position, and vice versa, when the door 1 is to be closed and the closure device locked. However, the bolt may be manually actuated via an actuating lever (not shown). The locking bolt may be actuated by a Bowden cable, a linkage, an electrical actuator, a solenoid, a hydraulic system or a pneumatic system. These are schematically shown.

Preferably, automatic control of the movement sequence of the locking bolt linked to the door movement is provided for the closure device. Automatic actuation of the locking bolt 4 takes place during opening/closing of the door 1 in this ease by means of a mechanical coupling to the door movement, e.g. via a Bowden cable 11, which interacts with a sensor device 12 as a function of the door movement. Instead of a Bowden cable, other transmission means may also be used, such as a linkage, an electrical actuator, a solenoid, a hydraulic system or a pneumatic system.

Sensing the impulse for movement of the locking bolt via a sensor device 12 may take place at any desired point between the door 1 and the frame 2, or alternatively via a hinge or inductively.

Optionally, a safety function may be provided in the event of a failure of the sensor device 12 or of the connection via, e.g., the Bowden cable 11, to move the automatically controlled locking bolt into a position which corresponds to the functioning position to ensure secure closure of the door 1.

The invention is not restricted to the examples illustrated and described but also encompasses all embodiments of equivalent effect, with variation of elements. In principle, virtually any individual feature may be omitted or replaced by at least an individual feature disclosed elsewhere.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A closure device for a door comprising:
a door frame, having a first side for supporting a door for swinging open and closed and a second side at which the closure device for the door is disposed;
a door having a first side swingably attached to the first side of the frame, the door swinging closed to fill the door frame at least at the first and second sides of the door frame and the door swinging open at the first side of the door frame;
a lock on one of the second side of the door frame and side of the door at the second side of the door frame, a locking bolt on the other of the second side of the door frame and the second side of the door for cooperating with the lock, with the lock and the locking bolt being positioned on the respective ones of the door frame and the door that with the door closed, the locking bolt engages the lock,
wherein the bolt and lock are of such type that when the lock and the locking bolt engage, the locking bolt is in a operational position projecting into the aperture defined by the frame and projecting toward the lock, and such that the locking bolt is also disposed on the respective side of the frame or the door to be moveable from its functioning position projecting into the door aperture to a nonfunctioning position, wherein the bolt does not project into the aperture of the frame, leaving the aperture of the frame free of the bolt in the non-functioning position of the bolt.

2. The closure device of claim 1, wherein the locking bolt includes a manually moveable operating element connected with the bolt for moving the bolt selectively into and out of the engagement with the lock.

3. The closure device of claim 1, further comprising an automatic actuation system connected with the door for being operated by operation of the door and being connected with the locking bolt for moving the locking bolt into the functioning position when the door is closed and moving the locking bolt into the non-functioning position when the door is opened.

4. The closure device of claim 3, further comprising a speed control device connected with the bolt for controlling the speed of movement of the bolt during transition between the functioning position and the non-functioning position upon movement of the door.

6. The closure device of claim 1, further comprising a mechanical actuating lever directly engaged with the locking bolt for moving the locking bolt between the functioning and non-functioning position thereof.

7. The closure device of claim 6, wherein the mechanical actuating lever is connected with an actuator for operating the locking bolt.

8. The closure device of claim 7, wherein the connection between the locking bolt and the mechanical actuating lever comprises a Bowden cable, a linkage, an electrical actuator, a solenoid, hydraulic system or a pneumatic system.

9. The closure device of claim 3, wherein the automatic actuation system comprises a sensor connected with the door for sensing movement of the door between the open and closed positions; and
the automatic actuation system for the locking bolt during the opening and closing of the door comprises a mechanical coupling associated with the door and operable by the movement of the door via the sensor.

10. The closure device of claim 9, wherein the mechanical coupling comprises a Bowden cable, a linkage, an electrical actuator, a solenoid, a hydraulic system or a pneumatic system.

11. The closure device of claim 1, wherein the locking bolt is disposed on the second side of the door frame and the lock is on the second side of the door at the second side of the frame.

12. The closure device of claim 11, wherein the locking bolt is moved linearly in translation.

13. The closure device of claim 11, wherein the locking bolt is rotated between the functioning position in the frame and the non-functioning position out of the frame.
